(19) United States
(12) Patent Application Publication
(10) Pub. No.: US 2013/0083650 A1
(43) Pub. Date: Apr. 4, 2013

(54) METHOD FOR HANDLING FAILURE OF A MME IN A LTE/EPC NETWORK

(71) Applicants: Tarik Taleb, Heidelberg (DE); Gottfried Punz, Dossenheim (DE); Stefan Schmid, Heidelberg (DE)

(72) Inventors: Tarik Taleb, Heidelberg (DE); Gottfried Punz, Dossenheim (DE); Stefan Schmid, Heidelberg (DE)

(73) Assignee: NEC EUROPE LTD., Heidelberg (DE)

(21) Appl. No.: 13/697,577

(22) PCT Filed: May 10, 2011
(86) PCT No.: PCT/EP2011/002312

§ 371 Date: Dec. 20, 2012

(30) Foreign Application Priority Data
May 11, 2010 (EP) 10004972.5

(51) Int. Cl. H04W 8/30

(52) U.S. Cl. CPC H04W 8/30
USPC 370/218

(57) ABSTRACT

Method for handling failure of a MME (Mobility Management Entity) in a Long Term Evolution/Evolved Packet Core network or an Evolved Packet System, wherein multiple UEs (User Equipment) are attached to a first MME, which stores first context information representing the UEs attached to the first MME, the UEs are connected to one of multiple eNBs (evolved NodeB), the eNB may communicate with the first MME and with at least one neighboring MME, and the UEs may communicate with the first MME and with the at least one neighboring MME via the eNB, includes: detecting failure of the first MME, gathering information related to UEs attached to the first MME, restoring parts of the first context information at one or several of the neighboring MME using the gathered information, and re-establishing network internal logical connections with the one or several of the neighboring MME using the restored first context information.

The present invention relates to a method for handling failure of a MME (Mobility Management Entity) in a LTE/EPC (Long Term Evolution/Evolved Packet Core) network or an EPS (Evolved Packet System), wherein multiple UEs (User Equipment) are attached to a first MME, wherein said first MME stores first context information representing the UEs attached to said first MME, wherein said UEs are connected to one of multiple eNBs (evolved NodeB) via a radio link, wherein said eNBs may communicate with said first MME and with at least one neighboring MME, and wherein said UEs may communicate with said first MME and with said at least one neighboring MME via said eNB.

At 3GPP's LTE/EPC wireless communication standard, the MME (Mobility Management Entity) is the key control node for the access network. The MME handles important procedures, such as idle mode UE (User Equipment) tracking and paging, and interacts with other core network entities at other important procedures like user authentication or bearer activation/deactivation. A MME may handle up to a few million UEs at the same time. In LTE/EPC networks, there are generally two or more MMEs.

During normal operation, each UE (active or in idle mode) is attached to a MME. Each MME stores context information which represents the attached UEs and their respective connections. The UEs may communicate with the MME via an eNB (evolved eNodeB) and vice versa. The communication between a UE and an eNB generally is performed via a radio link. An eNB is connected to the MME and other core network entities via an IP (Internet Protocol) based wired link.

As the MME is a central network entity, a MME failure handling scenario is defined in 3GPP standards. Relevant standards are:
[1] 3GPP TS 24.301 Non-Access-Stratum (NAS) protocol for Evolved Packet System (EPS);
[2] 3GPP TS 23.402 Architecture enhancements for non-3GPP accesses;
[3] 3GPP TS 23.007 Restoration Procedures;
[4] 3GPP TS 23.401 General Packet Radio Service (GPRS) enhancements for Evolved Universal Terrestrial Radio Access Network (E-UTRAN) access;
[5] 3GPP TS 24.302 Access to the 3GPP Evolved Packet Core (EPC) via non-3GPP access networks.

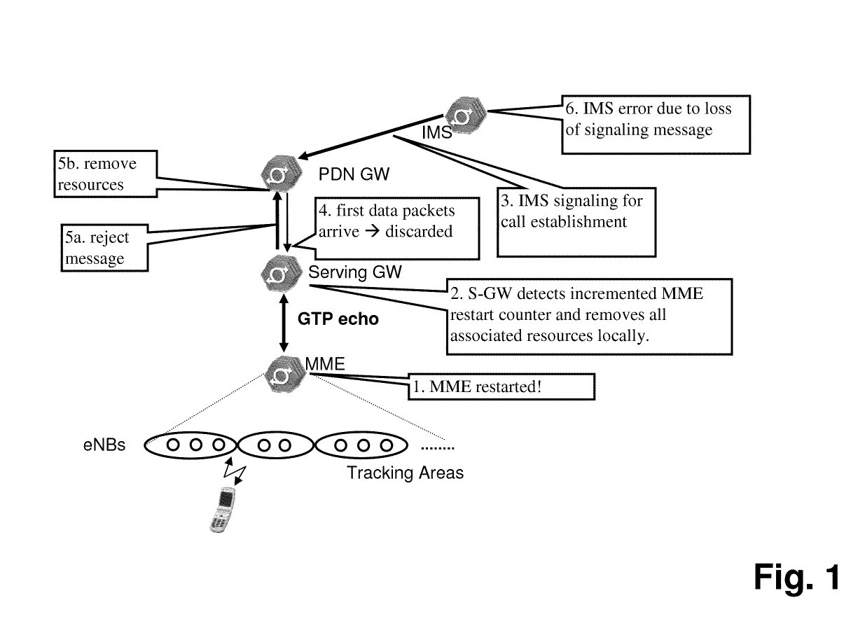

The MME failure scenario within the procedures defined in the 3GPP standards is depicted in FIG. 1. The diagram of FIG. 1 refers to standards valid at the priority date of the present application. FIG. 1 relates to the example of a terminating IMS (IP Multimedia Subsystem) call arriving after MME failure. At MME failure, the MME looses context information for the attached UEs.

At step 1, the MME restarts after failure. After the restart of the MME, the S-GW (Serving Gateway) detects the restart of the MME by incremented MME restart counter in a GTP (GPRS Tunneling Protocol) echo message (step 2). The S-GW removes all resources related to UEs handled previously on this MME. The removal of resources is not propagated directly up to the PDN-GW (Packet Data Network Gateway), i.e. the allocated IP (Internet Protocol) address and a S5/S8 (interface of the LTE/EPC network) tunnel configuration in PDN-GW remains valid.

At step 3, IMS signaling for call establishment arrives at the PDN-GW. Data packets (stemming from step 3) arrive at the S-GW and are discarded, due to unknown information e.g. GTP TEID (Tunnel Endpoint Identifier) or equivalent (step 4). The S-GW sends a reject message to the PDN-GW (step 5a) and the PDN-GW, upon receiving it, removes all resources linked to the relevant IP address (step 5b). The loss of the SIP (Session Initiation Protocol) signaling messages leads to an error situation in IMS (step 6). By performing these steps, invalid configurations are removed and the next IMS call will establish a new connection.

In February/March 2011, the restoration procedures were enhanced with optional capabilities. Now the S-GW does not necessarily remove all resources. At an IMS call, a core network internal repair process is initiated.

It is a drawback of the known failure handling that the restoration procedure has a significant impact on the delay of a call request. At the previous version of the standards, the first call request will be discarded. The call has to be initiated anew which is time-consuming and leads to a bad user experience. At the current version of the standard, the call request is generally successful but may be delayed significantly, as restoration of context information has to be performed.

It is therefore an object of the present invention to improve and further develop a method of the initially described type for handling MME failure in a LTE/EPC network in such a way that the impact on UEs (active or in idle mode) can be reduced.

In accordance with the invention, the aforementioned object is accomplished by a method comprising the features of claim 1. According to this claim, such a method is characterized by the steps of detecting failure of said first MME, gathering information related to UEs attached to said first MME, wherein the step of gathering information is triggered by the detection of said failure, restoring at least parts of said first context information at one or several of said neighboring MME using the gathered information, and re-establishing network internal logical connections with said one or several of said neighboring MME using the restored first context information

According to the invention it has first been recognized that the major drawback of the above-mentioned conventional solution results from the reactive approach, as it awaits the restart of the failed MME. According to the invention a pro-active approach is used. As soon as a failure of the MME is detected, MME relocation and restoration of the lost state is triggered in order to avoid service disruption at a later stage.

The present invention assumes that the LTE network comprises at least two MMEs. As this is true at most LTE networks, this assumption is no real restriction. Without loss of generality, the failing MME is subsequently called “first MME” and one or more neighboring MMEs will replace the first MME at its failure. Neighboring MMEs are MME(s) of the same service area and/or service pool. The context information stored at the first MME is subsequently called first context information. It should be understood that the first MME is not a specific MME within the LTE network. The “first MME” can be any failing or failed MME. It should be further understood that failure can be each state of “out of service”. For example failure can result from hardware breakdown, software hangs or planned maintenance. Further failure situations are possible and will become apparent to somebody skilled in the art.

According to the invention the health state of a MME is monitored, directly or indirectly. When a failure of the MME is detected, gathering of information related to UEs attached to the first MME is triggered. This information might include each data which can be used for restoration of the context information of the UEs. In a next step at least parts of the first context information are restored at one or several of said neighboring MME using the gathered information. Network internal logical connections with said one or several of said neighboring MME are re-established using the restored context information. MME relocation for the affected UEs may take place.

According to a preferred embodiment of the invention the step of detecting failure may be performed by network entities which are involved in the communication path of a UE. Such a network entity can be the eNB to which the UE is currently linked. The network entity can also consist of the S-GW at which the UE currently runs an ongoing communication. However, also other eNBs and S-GW which are communicatively linked with a MME can monitor the state of the MME. Also a neighboring MME might be a network entity which monitors the state of a MME. Most LTE/EPC networks also comprise an O&M (Operation and Maintenance) system. This system can also be a monitoring network entity according to this embodiment.

Detection of failure may be based on feedbacks from a supervising entity, based on periodic keep-alive/echo messages and their responses, based on explicit signaling, or based on the results of analysis of network entities. A great variety of information which already exist in the network may be used.

According to another preferred embodiment of the invention the step of gathering information includes sending an additional signaling message to a S-GW (Serving Gateway) at which a UE is currently registered. This additional signaling message may comprise a UE context update request or an Update assess bearer request. Preferably, the additional signaling message is sent on top of existing interfaces. This embodiment can be used at active mode UEs, i.e. at UEs with ongoing communication. S-GWs are controlled by a MME. With the failure of the MME, the control entity is lost. However, the S-GW may handle ongoing connections without MME. The S-GW stores context information which can be used at a new MME. Information retrieved from the S-SGW may be used for recovering UE's S1 bearer information. Using this embodiment of the invention, MME relocation may take place without impacting the user plane.

When using additional signaling message, the additional signaling messages may be transmitted for a set of active mode UEs. The set of UEs can be formed by UEs with common factors, like having same S-GW or to experience imminent handoffs. The set of UEs may be identified by a set identifier, e.g. a connection set ID. Preferably, the identifier is a unique identifier.

According to another preferred embodiment of the invention the step of gathering information includes sending paging signaling to eNBs and/or idle mode UEs which are affected by the failure of said first MME. This embodiment might be used particularly in connection with idle mode UEs. Paging signaling may be generated by a neighboring MME. The paging signaling will be received by the addressed eNBs which might forward the paging signaling to the UEs which have a radio link to the eNB. The paging signaling might also be generated by the eNB itself. The paging signaling generated by an eNB might also be transmitted to other eNBs which might be affected by the MME failure.

Preferably the paging signaling includes information regarding the failed first MME. Using this information, a UE or an eNB can evaluate whether a UE is affected by the failure of the MME.

Advantageously, paging signaling comprises bulk paging signaling, i.e. paging signaling which is addressed to multiple UEs and/or multiple eNBs. Using bulk paging reduces the traffic significantly, as not each single UE and/or eNB has to be addressed separately by paging signaling.

Paging may be initiated by one of the neighboring MMEs or by the eNB which detects failure of said first MME. If a neighboring MME sends paging signaling, it may notify other neighboring MMEs of the event in order to avoid duplicate paging. If duplicate paging occurs, the UE or the eNB may handle the first paging signaling and may discard the duplicates. Further a filter might eliminate duplicate paging.

In order to avoid overload of the system, paging signaling and/or responses to said paging signaling may be spread over time and/or may be performed per specific groups of UEs and/or eNBs. This may include that paging signaling is only sent to eNBs within a certain area (e.g. a tracking area) or that UEs with a certain priority metric are addressed. Further ways of grouping are possible. Alternatively or additionally, paging signaling or the response to the paging might be sent with a certain delay. This delay might be randomized.

For further reducing network traffic resulting from restoration, responses of the single UEs to paging signaling may be aggregated by the eNBs and may be sent as aggregated responses to the respective MMEs. The responses from different UEs which comprise one or some common aggregation criteria and which are received within a predefined time limit might be aggregated. Examples for suitable aggregation criteria might be a common new MME or same services. Aggregation will combine several responses to one response which contains the information of the single responses. With aggregation of the responses, the number of responses which have to be transmitted can be reduced considerably.

Additionally or alternatively responses received from the eNBs at a MME may be aggregated and may be sent as aggregated response to the HSS (Home Subscriber Server). This may reduce the number of responses even further. The aggregation at the MME may aggregate “normal” responses and/or aggregated responses.

After the step of re-establishing network internal connections, a UE may be re-attached to one of the neighboring MMEs according to the re-established logical connections. Re-attachment of said UE may be triggered by the paging signaling received from the eNB. For this reason, a special re-attachment flag may be added to the paging signaling. However, re-attachment of a UE may also be initiated by a service request message from the UE. This service request will fail and result in a TAU (Tracking Area Update). This indirect way of re-attachment uses methods which are commonly used in LTE/EPC networks. As the core network internal connections are already established, this re-attachment can be performed rather quickly.

In connection with the method according to the invention, a load balancing scheme may be executed. This may avoid overload of the network or parts of the network. The load balancing scheme can be performed particularly at selecting a new MME which handles the UEs affected by the failure of the MME.

In summary, the method according to the invention pro-actively re-establishes connections which were present before the MME failed. The duration of failure has no impact on the method. As soon as failure is detected, restoration and relocation is initiated. In the MME selection for UEs affected by the failed MME, load balancing operation might be executed in order to redistribute and re-attach the affected UEs based on the load at the respective MMEs.

For better understanding of the invention some key features are given with respect to a preferred embodiment:
1. A solution to guarantee service continuity in 3GPP networks (EPS, LTE/EPC networks, etc.) in case of MME failure through pro-active resilience mechanisms across nodes in the radio access and core networks is provided.
2. MME failure detection is performed by O&M, eNBs using S1-MME, by neighboring MMEs using S10, or directly by S-GWs using S11.
3. A set of eNBs is triggered to perform bulk paging of idle mode UEs affected by a MME failure. The failed MME information is used as identifier in the page message and information relevant for overload avoidance (e.g. randomization data).
4. A set of MMEs triggers bulk paging of idle mode UEs affected by a MME failure, indicating the failed MME and providing indicators for overload avoidance.
5. A MME that first detects the failure of its neighbor immediately starts the bulk paging and notifies the neighboring MMEs (e.g. all MMEs of the same service area/pool) of the event in order to avoid duplicate paging.
6. Upon detecting the failure of a MME, O&M notifies the neighboring MMEs and indicates to each MME which TA (Tracking Area) and/or which group of UEs to page, also to avoid duplicate paging.
7. eNBs filter out all duplicate paging messages for the same UE.
8. Overload of particular MMEs/eNBs is avoided via scheduled paging of UEs and/or scheduled responses from UEs based on randomization over a defined time interval.
9. Overload of particular MMEs/eNBs is avoided via prioritized paging of UEs and/or responses from UEs based on different metrics (e.g., access class, subscription, UE's unique IDs).
10. eNBs hold back the TAU Requests and/or MMEs hold back Update Location Requests and/or Create/Update Service Requests in order to aggregate these requests and minimize the signaling load on the network/relevant interfaces and processing load at the receiving end (i.e. the MME for the TAU Requests, the HSS for the Update Location Requests, and the S/P-GWs for the Create/Update Service Requests).
11. Following a MME failure and for each affected active mode UEs, eNBs trigger a selected MME to recover UE's S1 bearer information (from S-GWs and other network elements) using additional signaling messages (e.g., UE context update request, Update access bearer request) on top of existing interfaces. MME relocation takes place here without impacting the user plane.
12. Recovering UEs' S1 bearer information can be done for a set of active mode UEs with common factors (e.g., having same S-GW or to experience imminent handoffs) and identified by a unique identifier (e.g., connection set ID)

The key concept behind the devised solutions according to the present invention is to pro-actively trigger MME relocation and restoration of lost state to avoid service disruption at a later stage. In particular, the innovation comprises the following cases:
For idle mode UEs: Trigger all affected idle-mode UEs through “scheduled bulk paging” to re-attach to the network.
For active mode UEs: Allow ongoing communications to proceed and trigger UEs in a scheduled manner (e.g. high priority UEs first) to perform a Tracking Area Update.

Both mechanisms lead to the selection of a new MME for the UE and restoration of its context in a pro-active manner.

A number of supporting mechanisms are also considered. These mechanisms are related to:
i) MME failure detection
ii) Bulk Paging of all affected UEs in idle mode
   a. MME-initiated paging (on S1AP (S1 interface, Application Part) and RRC (Radio Resource Control))
   b. eNB-initiated paging (on RRC, using PCCH (Paging Control Channel) channels or BCCH (Broadcast Channel) channels)
iii) Overload avoidance
   a. scheduling paging and responses at MMEs, eNBs, UEs, or at a combination of the three to cope with the limited capacities of MMEs (e.g., maximum number of TAU requests to be processed per second)
   b. Batch TA Update procedure
iv) eNB-initiated MME restoration for affected UEs in active mode.

The proposed solution scheme is characterized by these features:
1. Early and thus pro-active MME restoration (i.e., support of immediate service initiation, no need to wait till the restart of the failed MME nor for the next UE triggered action);
2. Bulk paging of all affected UEs on the radio interface and/or S1-AP interface (based on the MME information as identifier in the paging message) whilst taking into account load balancing and overload avoidance;
3. Maintenance of ongoing connections for ECM-connected UEs even after failure of the corresponding MME (i.e., no service disruption).

Detection of a MME failure can be achieved
Via an explicit intervention/notification from O&M
   O&M detects failure i) based on feedback from supervising SW daemons on the MMEs, ii) based on periodic keep-alive/echo messages and responses, iii) having MME immediately send an alarm to O&M right before it crashes—very possible in case of partial failure, or iv) by analyzing related information (e.g., handover occurrences) from other network elements such as eNBs, S-GWs, P-GWs, etc.
directly by eNBs using S1-MME (i.e., using keep-alive messages of SCTP protocol as in RFC 4960),
directly by neighboring MMEs using S10 protocol means (e.g., using echo messages of GTP-C, or having MME immediately send an alarm to one or more neighboring MME right before it crashes. The latter informs the other MMEs, etc), or
directly by S-GWs using S11 protocol means (e.g., using echo messages of GTP-C, providing related information to O&M for analysis).

The proposed solution scheme is characterized by these features:
1. Early and thus pro-active MME restoration (i.e., support of immediate service initiation, no need to wait till the restart of the failed MME nor for the next UE triggered action);
2. Bulk paging of all affected UEs on the radio interface and/or S1-AP interface (based on the MME information as identifier in the paging message) whilst taking into account load balancing and overload avoidance;
3. Maintenance of ongoing connections for ECM-connected UEs even after failure of the corresponding MME (i.e., no service disruption).

The method according to the present invention presents a proactive solution to deal with MME restoration. For example, the proposed methods can be integrated into eNBs, MME, O & M, UEs.

There are several ways how to design and further develop the teaching of the present invention in an advantageous way. To this end it is to be referred to the patent claims subordinate to patent claim 1 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing:

FIG. 1 is a diagram illustrating the MME failure scenario as known in the art (defined in 3GPP standards),

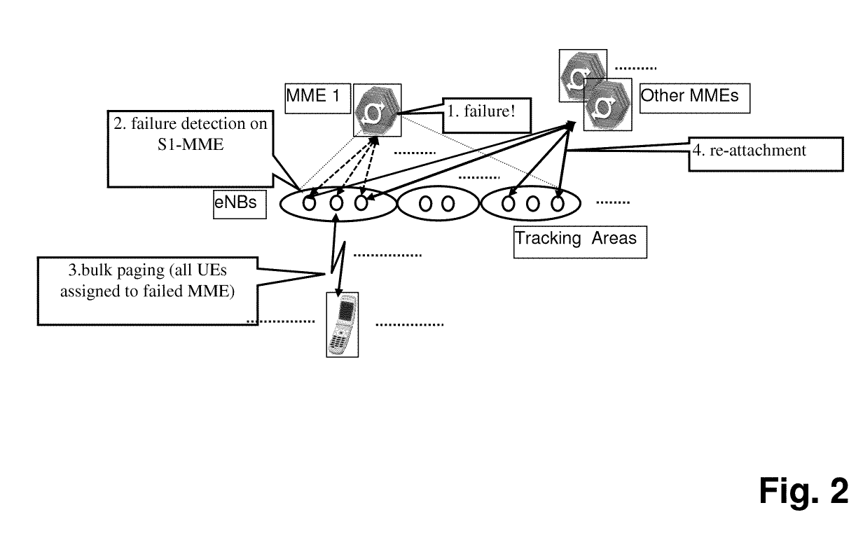

FIG. 2 is a diagram illustrating a first embodiment of the invention using eNB-initiated paging,

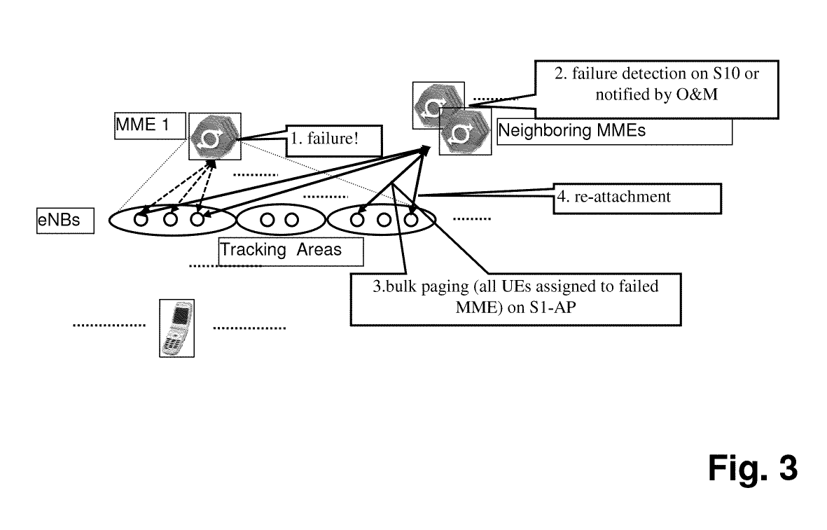

FIG. 3 is a diagram illustrating a second embodiment of the invention using MME-initiated paging,

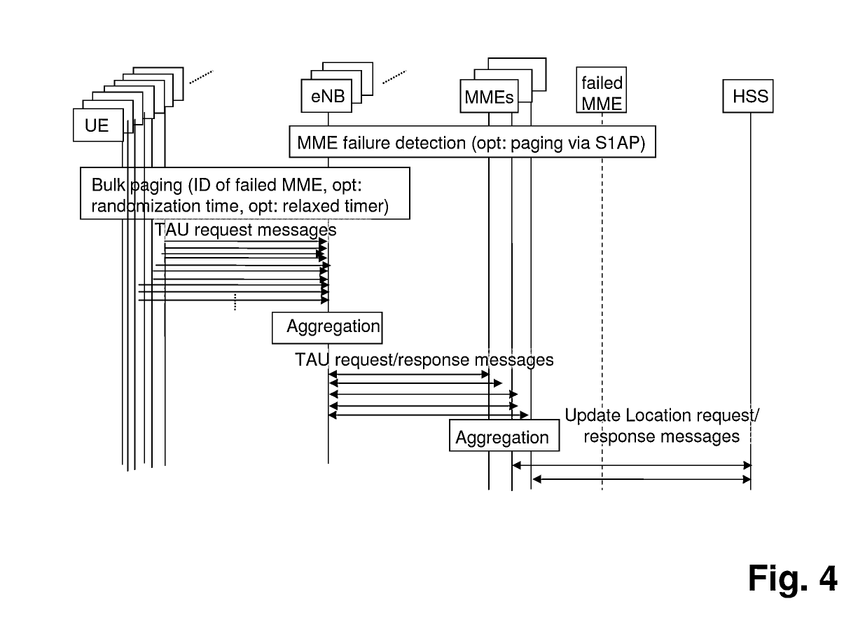

FIG. 4 is a signal flowchart illustrating idle mode signaling for re-distributing UEs to operative MMEs after MME failure, and

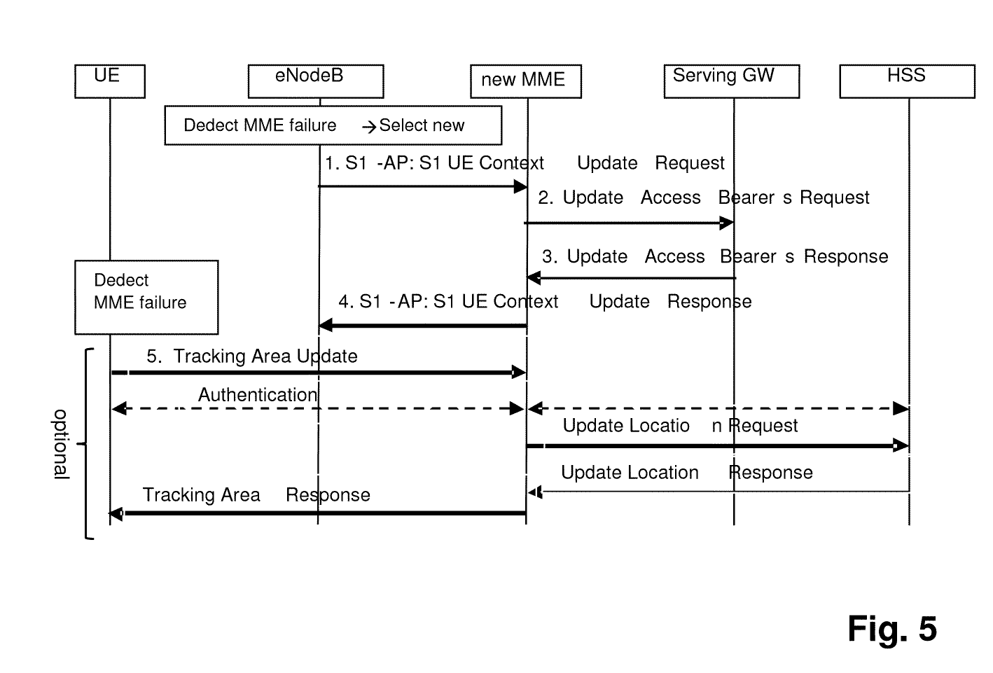

FIG. 5 is a signal flowchart illustrating a third embodiment of the invention with eNB-initiated MME restoration for UEs which are affected by MME failure and which are in connected mode.

FIG. 2 shows a first embodiment of the invention with eNB-initiated paging (on L2 radio channels) for affected UEs in idle mode. The proposed procedure is based on an enhancement in the paging procedure that enables paging of all UE's that have been served by a particular MME (i.e. the “bulk” paging is characterized by the use of MME information—which is the leading part of GUTI—as identifier).

The steps in detail are:
1. MME 1 has failed;
2. All eNBs with S1-MME connection to MME 1 detect the failure;
3. All eNBs detecting the MME failure initiate bulk paging of all idle mode UEs being served by the failing MME, with identity of the failed MME and some indicators for overload avoidance (e.g., randomization time interval)
4. During the re-attachment the eNBs re-distribute the UEs on the MMEs remaining in operation.

The service request procedure initiated by the UE as response to the paging will lead indirectly to a re-attach, in the following sequence:
1. The UE sends the SERVICE REQUEST message to the eNB;
2. Due to the failure of the originally assigned MME, the eNB needs to re-distribute the UE to another MME by releasing the RRC connection, using the cause “loadBalancingTAURequired”;
3. The UE will re-establish the RRC connection and subsequently perform a TAU;
4. The (new) MME will respond with cause #9 (“UE identity cannot be derived”); this leads the UE into EMM-DEREGISTERED, from where it can re-attach.

Such a mechanism would in principle trigger many UEs to re-attach at the same time, but the re-attach attempts should be spread out over time to avoid overload at the newly selected MMEs; this can be achieved by different mechanisms explained in the section “Overload Avoidance”.

Alternatively to the above-mentioned Service Request-based procedure, the UE may also re-attach to the network after receiving a paging message as a result of an MME failure (i.e., indicated via a flag in the paging message) and that is following the attach procedure as described in clause 5.3.2 of [4].

FIG. 3 relates to a second embodiment of the invention with MME-initiated paging (on S1-AP interface) for affected UEs in idle mode. In this embodiment, MME failure is detected by neighboring MMEs and paging of UEs is initiated by MMEs that are in the neighborhood of the affected MME—e.g. another MME in the same service area (“pool”). Here, a MME A is said to be a neighbor of MME B if both MMEs have at least one common Tracking Area. As schematically depicted in FIG. 3, the steps of this solution are as follows:
1. MME 1 has failed;
2. One or more neighboring MMEs or S-GW detect the failure (e.g. based on GTP echo messages);
3. The neighboring MMEs detecting the MME failure initiate bulk paging on S1-AP (addressing idle mode UEs), with identity of the failed MME and some indicators for overload avoidance (e.g., randomization time interval), to trigger corresponding UEs to re-attach to the network (e.g., indicating “load balancing TAU required” as in clause 5.3.5 of 23.401);
4. UEs re-attach to the network.

In this solution, duplicate paging shall be minimized, if not entirely avoided. This can be achieved via different methods: 1.) In case a neighbor MME detects the MME failure, it immediately starts the paging and notifies its neighboring MMEs that it has already paged the concerned UEs and there is no need to do that from their side. This mechanism assumes that MMEs have prior knowledge on the pool of MMEs that are able to cover a failing MME. 2.) In case O&M detects the MME failure and notifies the neighboring MMEs, O&M can explicitly indicate to each MME which Tracking Area it should page. 3.) The eNBs filter out duplicated paging messages (stemming from different MMEs) to a single UE.

In case of an inevitable reception of duplicate paging, a UE simply considers the first paging message and discards the following ones.

For the sake of load balancing, the concerned eNBs run a MME Load Balancing scheme (excluding the failed MME) to ensure that not all UEs would connect to the same MME (e.g., following clause 4.3.7.3 of 23.401).

For the sake of overload avoidance in addition to the MME related load balancing scheme (excluding the failed MME) by eNBs, we propose the following mechanisms that shall contribute to overload avoidance in general (i.e. also on eNBs):

Bulk paging at MMEs or eNBs can be performed per specific groups of UEs, based on certain priority metrics (e.g., access class), or in a randomized manner using a predefined randomization time.

Responses from UEs can be carried out in a randomized manner and over a time interval following a hash function that takes UEs' unique identifiers (e.g., IMSI, S-TMSI, etc), subscription information available at UE, etc) as input values (based on new UE functionality).

The two above-mentioned mechanisms can be jointly carried out.

FIG. 4 relates to idle mode signaling for re-distributing UEs to operative MMEs after MME failure. Given constraints in the maximum number of Tracking Area Updates an MME can handle per second, we propose that in case of MME restoration, eNB can also hold back the TAU Requests and/or MME holds back TAU requests and location update requests towards the HSS in order to aggregate several location updates towards the HSS and/or Create/Update Service requests to the S/P-GWs (see FIG. 4). For example, the MME waits for a predefined timeout or till a number of TAU requests arrive (or both) to proceed with a bulk of Location Updates towards the HSS. Usually, for a TAU request, a UE sets up a timeout (i.e., 15 s as in [5]) within which TAU accept message should be received. Whilst 15 s is sufficiently long, should it be required, this timeout could be increased in case of TAU following specific events such as MME failure.

In the following, Update Location Request messages are used as an example to explain the gain that the network may make out of the above-mentioned bulk signaling handling. As defined in TS 29.272, section 5.2.1.1, these are the relevant information elements in Update Location request message (M . . . Mandatory, O . . . Optional, C . . . Conditional):
IMSI (M),
Supported Features (O),
Terminal Information (O),
ULR Flags (M),
Visited PLMN Id M (M),
RAT Type (M),

Only IMSI and Terminal Information will differ between the many requests to be handled; this means that the message contents can be compacted considerably. Moreover, the effort of parsing the parameters of many messages is also reduced to a minimum, which shall reduce by a large factor the time spent for restoration.

FIG. 5 relates to a third embodiment of the invention with eNB-initiated MME restoration for UEs which are affected by MME failure and which are in connected mode. Regarding UEs in Connected mode and which are affected by a MME failure, the objective is to get their contextual information (previously available at the failed MME) which is distributed over different network entities (e.g., S-GW, P-GW, eNB, etc) without impacting the ongoing sessions of the UEs. The state of the art solution is to duplicate/mirror all information in highly resilient nodes/data base implementations of MMEs. So whenever a MME fails, the UE contextual information can be recovered instantaneously from these mirrors. However, this comes at high costs. Additionally, in order to cater for large disasters (e.g. earthquakes), this solution would have additionally to be enhanced with geographical distribution. In contrast, the solution described here is based on more intelligent, cooperative behavior of network elements, which allows a considerably simpler and thus cheaper MME implementation.

In particular, a newly selected MME (after failure of the serving MME) will recover the state information for the eNB (step 1) and Serving GW (step 3). The state information recovered by the new MME from the Serving GW (in step 3) include per UE bearer information such as:
IMSI;
ME Identity;
MSISDN;
S-GW TEID for S11/S4 (control plane);
S-GW IP address for S11/S4 (control plane);
Last known Cell Id;
Last known Cell Id age;
APN in Use;
EPS PDN Charging Characterisitcs;
P-GW Address in Use (control plane);
P-GW TEID for S5/S8 (control plane);
P-GW Address in Use (user plane);
P-GW GRE Key for uplink traffic (user plane);
S-GW IP address for S5/S8 (control plane);
S-GW TEID for S5/S8 (control plane);
S-GW Address in Use (user plane);
S-GW GRE Key for downlink traffic (user plane);
Default Bearer;
TFT;
S-GW IP address for S1-u, S12 and S4 (user plane);
S-GW TEID for S1-u, S12 and S4 (user plane);
eNodeB IP address for S1-u;
eNodeB TEID for S1-u;
RNC IP address for S12;
RNC TEID for S12;
SGSN IP address for S4 (user plane);
SGSN TEID for S4 (user plane);
EPS Bearer QoS;
Charging Id.

The state information recovered by the new MME from the eNB (in step 1) include per UE:
Selected Network;
EPS Bearers information (TEID and address of the eNodeB);
AMBR.

Since per UE and EPS bearer information must be exchanged for many UEs, the information exchange between eNB/S-GW and MME (steps 1-4) can also be achieved by means of bulk signaling (i.e. per UE and EPS bearer information can be aggregated in a single signaling exchange).

The flowchart of the proposed solution is shown in FIG. 5. The mechanism is applied by each eNB being in a tracking area that was serviced by the failed MME. It concerns only UEs in connected mode that have been registering with the failed MME. Note that an eNB can easily sort out these UEs. The steps of this solution are as follows:
0. eNB detects MME failure and selects a new one out of the remaining MMEs in operation. Load balancing is taken into account in the selection of a new MME. MME selection can be done for an individual active UE or for a set of active UEs with common factors (e.g., having assigned the same S-GW, those to experience imminent handoffs) and defined by a unique identifier (e.g., Connection Set ID according to [3]) allocated locally. Prioritization among the UEs or the formed sets of UEs can be envisioned, i.e., intuitively UEs with imminent handoffs should be prioritized over other UEs.
1. eNB sends UE's S1 bearer information to the selected MME requesting a UE context update. Some of the provided context could be UE's IMSI, corresponding S-GW, Reason for Update (i.e., failure of MME X), etc. A bulk of update requests can be also performed for each formed set of UEs (as mentioned in the previous step).
2. MME then sends an Update Access Bearers request to the corresponding S-GW querying UE's S1 bearer information. MME, in turn, can also group UEs into different groups, uniquely and locally identified, and send a bulk of update bearer requests for each formed group of UEs.
3. In response, S-GW sends an Update Access Bearer Response. Here, the information on the corresponding P-GW can be also included.
4. As confirmation, the newly selected MME responds with a S1 UE context update response to the eNB.
5. When UE detects MME failure (e.g., based on error message following an attempt to initiate a new PDN connection using old GUTI) or is triggered to perform TAU (e.g., by eNB via a RRC connect signaling message), it sends a tracking area update. MME relocation will then take place without impacting the user plane.

It should be noted that while in the above described flow, the TAU request is handled for each individual UE in connected mode, the same bulk signaling handling described in FIG. 4 could be applied.

Many modifications and other embodiments of the invention set forth herein will come to the mind of the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for handling failure of a MME (Mobility Management Entity) in a LTE/EPC (Long Term Evolution/Evolved Packet Core) network or an EPS (Evolved Packet System),
wherein multiple UEs (User Equipment) are attached to a first MME,
wherein said first MME stores first context information representing the UEs attached to said first MME,
wherein said UEs are connected to one of multiple eNBs (evolved NodeB),
wherein said eNB may communicate with said first MME and with at least one neighboring MME, and wherein said UEs may communicate with said first MME and with said at least one neighboring MME via said eNB,
characterized by the steps of
detecting failure of said first MME,
gathering information related to UEs attached to said first MME, wherein the step of gathering information is triggered by the detection of said failure,
restoring at least parts of said first context information at one or several of said neighboring MME using the gathered information, and
re-establishing network internal logical connections with said one or several of said neighboring MME using the restored first context information.

2. Method according to claim 1, wherein the step of detecting failure is performed by an eNB, by one of said neighboring MME, by an S-GW (Serving GateWay) or by an O&M (Operation and Maintenance) system.

3. Method according to claim 1, wherein the step of detecting failure is based on feedbacks from a supervising entity, based on periodic keep-alive/echo messages and their responses, based on explicit signaling, or based on the results of analysis of network entities.

4. Method according to claim 1, wherein the step of gathering information includes sending an additional signaling message to a S-GW (Serving GateWay) at which a UE is currently registered, wherein said additional signaling message preferably comprises a UE context update request or a Update assess bearer request.

5. Method according to claim 4, wherein said additional signaling messages are transmitted for a set of active mode UEs, wherein the UEs within one set of UEs comprise common factors and wherein the UEs within one set of UEs are preferably identified by a set identifier.

6. Method according to claim 1, wherein the step of gathering information includes sending paging signaling to eNBs and/or idle mode UEs which are affected by the failure of said first MME, wherein said paging signaling preferably includes information regarding said failed first MME.

7. Method according to claim 6, wherein said paging signaling comprises bulk paging signaling, i.e. paging signaling which is addressed to multiple idle mode UEs and/or multiple eNBs.

8. Method according to claim 6, wherein paging is initiated by one of the neighboring MMEs or by the eNB which detects failure of said first MME.

9. Method according to claim 8, wherein a neighboring MME which sends paging signaling notifies other neighboring MMEs of the event in order to avoid duplicate paging.

10. Method according to claim 8 wherein the step of detecting failure is performed by an eNB, by one of said neighboring MME, by an S-GW (Serving Gateway) or by an O&M (Operation and Maintenance) system, and, wherein said O&M notifies the neighboring MMEs and indicates to each MME which tracking area and/or which group of UEs to page in order to avoid duplicate paging.

11. Method according to claim 6, wherein paging signaling and/or responses to said paging signaling are spread over time and/or are performed per specific groups of UEs and/or eNBs.

12. Method according to claim 6, wherein responses of the single UEs to said paging signaling are aggregated by the eNBs and are sent as aggregated responses to the respective MMEs.

13. Method according to claim 6, wherein responses received from the eNBs at a MME are aggregated and are sent as aggregated response to the HSS (Home Subscriber Server).

14. Method according to claim 1, wherein after said step of re-establishing network internal connections, a UE is re-attached to one of the neighboring MMEs according to the re-established logical connections.

15. Method according to claim 14, wherein re-attachment of said UE is triggered by said paging signaling received from said eNB,

16. Method according to claim 14, wherein re-attachment of said UE is initiated by a service request message from said UE, wherein failure of said service request results in a TAU (Tracking Area Update).

17. Method according to claim 1, wherein a load balancing scheme is executed in order to avoid overload of the network or parts of the network.

18. Method according to claim 2, wherein the step of detecting failure is based on feedbacks from a supervising entity, based on periodic keep-alive/echo messages and their responses, based on explicit signaling, or based on the results of analysis of network entities.

19. Method according to claim 7, wherein paging is initiated by one of the neighboring MMEs or by the eNB which detects failure of said first MME.
